(19) United States
(12) Patent Application Publication
(10) Pub. No.: US 2014/0215203 A1
(43) Pub. Date: Jul. 31, 2014

(54) PROTECTION DEVICE, PROTECTION METHOD AND ELECTRONIC SYSTEM THEREOF

(71) Applicant: WISTRON CORPORATION, New Taipei City (TW)

(72) Inventors: Chien-Liang Chen, New Taipei City (TW); Chien-Fu Liao, New Taipei City (TW)

(73) Assignee: WISTRON CORPORATION, New Taipei City (TW)

(21) Appl. No.: 13/854,147

(22) Filed: Apr. 1, 2013

(30) Foreign Application Priority Data
Jan. 31, 2013 (TW) 102103804

(51) Int. Cl. G06F 9/44

(52) U.S. Cl. CPC G06F 9/4421
USPC 713/100

(57) ABSTRACT

A protection device for an electronic system includes a detecting module, coupled between a power supply device and a computing device of the electronic system for generating a current instruction signal according to the current value of a supply current transmitted from the power supply device to the computing device; a determining module, coupled to the detecting module for generating a control signal according to the current instruction signal and at least one threshold; and a performance adjusting module, coupled to the determining module and the computing device for adjusting the performance of the computing device according to the control signal.

### BACKGROUND OF THE INVENTION

1. Field of the Invention

The present invention relates to a protection device, a protection method and an electronic system thereof, and more particularly, to a protection device, a protection method and an electronic system thereof capable of adjusting performance of an electronic system according to a supply current in the electronic system.

2. Description of the Prior Art

In advanced electronic engineer technology, weights and sizes of many electronic devices are significantly reduced to allowing the electronic devices to be portable. The electronic devices such as mobile phones, personal digital assistants (PDAS), digital cameras, potable multi-media playing devices (e.g. walkman), laptops and tablets are widely used in the modern society. Generally, the portable electronic devices utilize electrical storage components (e.g. the batteries) as the power resource.

Besides, with the advance of portable electronic devices such as mobile communication devices, notebooks and electronic books, more and more functions are being integrated in the portable electronic devices. Including essential functions (e.g. communication function of the mobile communication devices, document processing function of the notebooks and reading function of the electronic books), the portable electronic devices further have secondary functions such as game functions, multimedia playback functions and navigation functions. Furthermore, with the improvement of the hardware specifications of the portable electronic devices (e.g. the increase of the number of cores of the CPU and the increase of the operating frequency of the CPU), the power consumption of the electronic devices significantly grows when the electronic device operates in heavy loading state (e.g. when the portable electronic device simultaneously performs multiple functions or executes complex calculating program). In such a condition, the battery of the portable electronic device needs to provide considerable current for keeping the portable electronic device works normally. When the battery consistently provides considerable current to the portable electronic device, the service life (e.g. rechargeable times and the maximum electricity) of the battery will be gradually decreased, however. The battery of the portable electronic device may need to be replaced by a new battery often or the battery may need to be charged frequently.

### SUMMARY OF THE INVENTION

Therefore, the present invention provides a protection device, a protection method and electronic system thereof for adjusting performance of an electronic system according to a current value of total consumption current in the electronic system, to avoid the service life of the battery significantly decreases.

The present invention discloses a protection device for an electronic system. The protection device comprises: a detecting module, coupled between a power supply device and a computing device of the electronic system for generating a current instruction signal according to the current value of a supply current transmitted from the power supply device to the computing device; a determining module, coupled to the detecting module for generating a control signal according to the current instruction signal and at least one threshold; and a performance adjusting module, coupled to the determining module and the computing device for adjusting the performance of the computing device according to the control signal.

The present invention further discloses an electronic system. The electronic system comprises: a computing device; a power supply device, for providing a supply current to the computing device; and a protection device, comprising: a detecting module, coupled between a power supply device and a computing device for generating a current instruction signal according to the current value of a supply current transmitted from the power supply device to the computing device; a determining module, coupled to the detecting module for generating a control signal according to the current instruction signal and at least one threshold; and a performance adjusting module, coupled to the determining module and the computing device for adjusting the performance of the computing device according to the control signal.

The present invention further discloses a protection method for an electronic system. The protection method comprises: detecting a current value of a supply current transmitted from a power supply device to a computing device of the electronic system; and adjusting performance of the computing device according to the current value of the supply current and at least one threshold

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic system according to an embodiment of the invention.

FIG. 2 is a schematic diagram of a realization method of the electronic system shown in FIG. 1.

FIG. 3 is a schematic diagram of related signals when the electronic system shown in FIG. 2 operates.

FIG. 4 is a schematic diagram of another realization method of the electronic system shown in FIG. 1.

FIG. 5 is a schematic diagram of related signals when the electronic system shown in FIG. 4 operates.

FIG. 6 is a flowchart of a protection method according to an embodiment of the invention.

### DETAILED DESCRIPTION

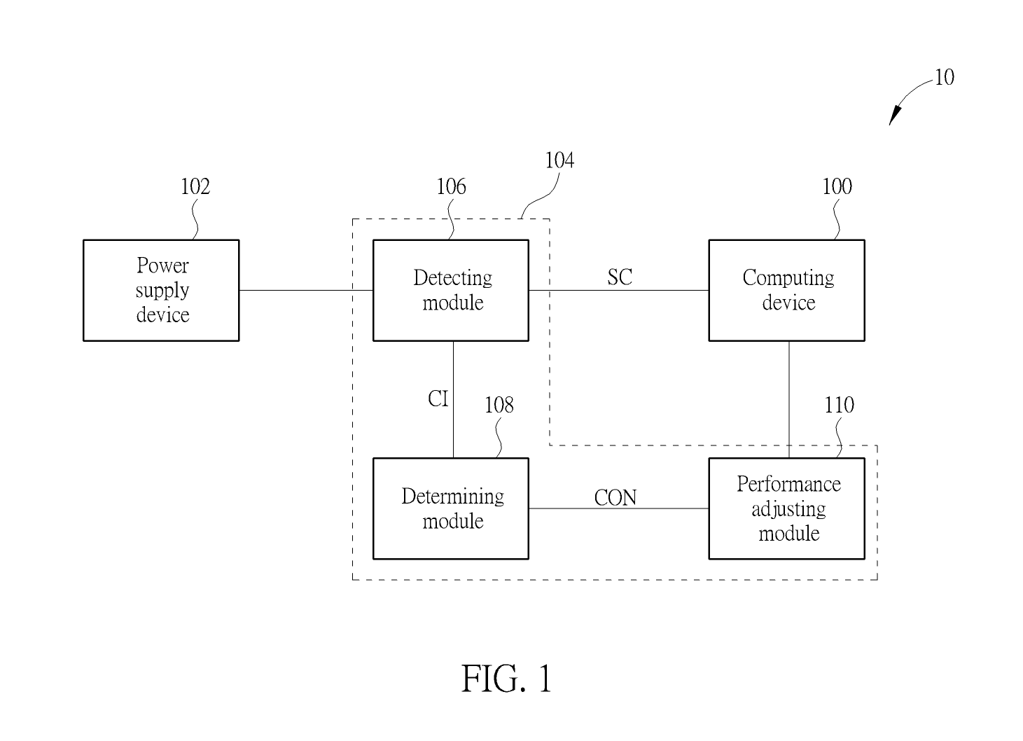

Please refer to FIG. 1, which is a schematic diagram of an electronic system according to an embodiment of the invention. The electronic system 10 may be a portable electronic device such as a mobile phone, a PDA, a digital camera, a portable multi-media device, a laptop and a tablet, but is not limited herein. As shown in FIG. 1, the electronic system 10 comprises a computing device 100, a power supply device 102 and a protection device 104. The computing device 100 is a central processing unit (CPU) or other computing components of the electronic system 10. The power supply device 102 is an electricity storage component (e.g. a battery) and is utilized for providing a supply current SC to the computing device 100. The protection device 104 is coupled between the computing device 100 and the power supply device 102 for reducing performance of the computing device 100 when the supply current exceeds a current threshold CTH, to avoid the power supply device 102 consistently outputs oversized current and reduces service life thereof. In brief, the protection device 104 adjusts the performance of the computing device 100 according to the supply current SC transmitted from the power supply device 102 to the computing device 100, for preventing the service life of the power supply device 104 from significantly decreasing due to the oversized supply current SC.

In detail, the protection device 104 comprises a detecting module 106, a determining module 108 and a performance adjusting module 110. The detecting module 106 is coupled between the computing device 100 and the power supply device 102 for detecting the current value of the supply current SC, to generate a current instruction signal CI. The determining module 108 is coupled to the detecting module 106 for generating a control signal CON according to the current instruction signal CI. The performance adjusting module 110 (e.g. a micro processor or a General Purpose Input/Output (GPIO)) is coupled to the computing device 100 and the determining module 108 for adjusting the performance of the computing device 100 according to the control signal CON. When the determining module 108 acquires the current value of the supply current SC is greater than the current threshold CTH according to the current instruction signal CI, the determining module 108 generate the appropriate control signal CON for controlling the computing device 100 to enter a protection mode via the performance adjusting module 110. When the computing device 100 enters the protection mode, the computing device 100 will reduce the performance thereof and the supply current SC transmitted from the power supply device 102 to the computing device 100 will be gradually decreased. For example, if the computing device 100 is a multi-core CPU, the computing device may decrease the number of operating cores or the operating frequency to reduce the performance thereof when the computing device 100 enters the protection mode. Next, when the determining module 108 acquires the current value of the supply current SC is smaller than the current threshold CTH according to the current instruction signal CI, the determining module 108 generate the appropriate control signal CON for controlling the computing device 100 to leave a protection mode. According to the above, the protection device 104 adjusts the performance of the computing device 100 according to the supply current SC transmitted from the power supply device 102 to the computing device 100, to avoid the service life of the power supply device 102 being reduced by the oversized supply current SI.

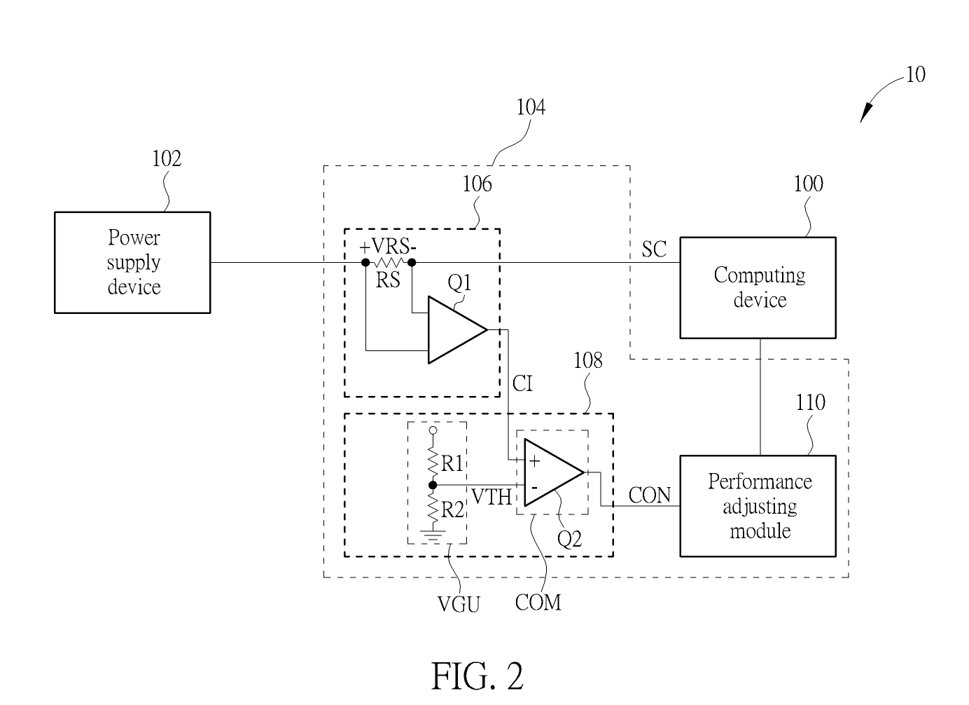

According to different applications, there are various methods to realize the protection device 104. Please refer to FIG. 2, which is a schematic diagram of a realization of the electronic system 10 shown in FIG. 1. As shown in FIG. 2, the detecting module 106 comprises a sensing resistor RS and an amplifying unit Q1. The determining module 108 comprises a voltage generating unit VGU and a comparing unit COM. When the computing device 100 operates, the supply current SC provided by the power supply device 102 passes through the sensing resistor RS and generates a sensing voltage VRS across the sensing resistor RS, wherein the sensing voltage VRS is proportional to the current value of the supply current SC. In order to minimize the power consumption on the sensing resistor RS, the resistance of the sensing resistor RS should be designed as small as possible. Thus, the sensing voltage VRS needs to be amplified by the amplifying unit Q1 (e.g. amplified 50 times) for being the current instructing signal CI. The voltage generating unit VGU comprises resistors R1, R2 for generating a voltage threshold VTH corresponding to the current threshold CTH. The comparing unit COM is realized by an amplifying unit Q2. The amplifying unit Q2 comprises two inputs coupled to the current instruction signal CI and the voltage threshold VTH, respectively and is utilized for generating the control signal CON according to a relation between the current instruction signal CI and the voltage threshold VTH. When the current value of the supply current SC is oversized, the current instruction signal CI will exceed the voltage threshold VTH. The amplifying unit Q2 then outputs the control signal CON instructing the supply current SC is oversized for making the performance adjusting module 110 controls the computing device 100 to enter the protection mode. When the current value of the supply current SC backs to normal region, the current instruction signal CI will be smaller than the voltage threshold VTH. The amplifying unit Q2 then outputs the control signal CON instructing the supply current SC is normal for making the performance adjusting module 110 controls the computing device 100 to leave the protection mode. In other words, the comparing unit COM generates the appropriate control signal CON via comparing the current instruction signal CI and the voltage threshold VTH, for instructing the performance adjusting module 110 whether to control the computing device 100 to enter the protection mode.

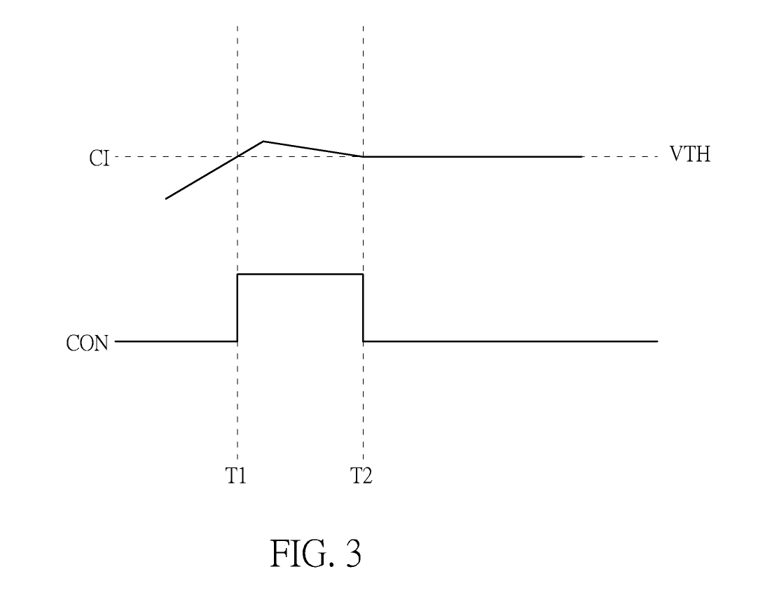

Please refer to FIG. 3, which is a schematic diagram of related signals when the electronic system 10 shown in FIG. 2 operates. As shown in FIG. 3, the current instruction signal CI gradually increases with the current value of the supply current SC gradually arises. At a time T1, the current instruction signal CI exceeds the voltage threshold VTH corresponding to the current threshold CTH, resulting in the control signal CON switches to a high logic. In such a condition, the performance adjusting module 110 controls the computing device 100 to enter the protection mode and the current value of the supply current SC is therefore decreased. At a time T2, the current instruction signal CI decreases to be lower than the voltage threshold VTH, resulting in the control signal CON switches to a low logic. The performance adjusting module 110 controls the computing device 100 to leave the protection mode, and then the computing device 100 retains the current power consumption.

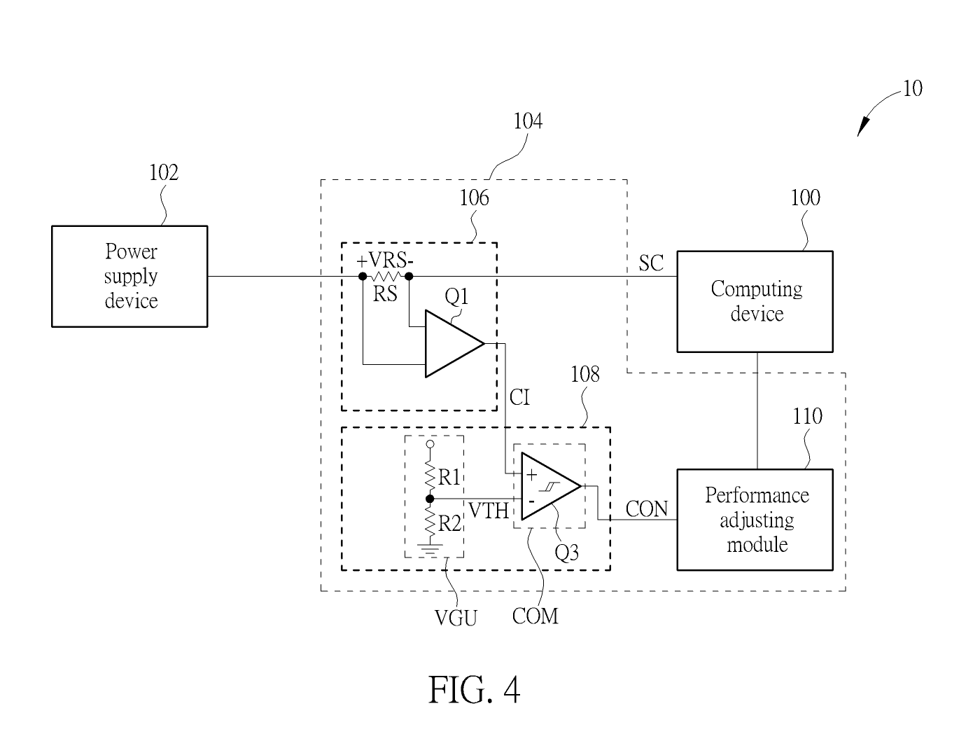

Please note that, the spirit of the above embodiments is adjusting the performance of the computing device according to the supply current transmitted from the power supply device to the computing device, for reducing the performance of the computing device when the supply current is oversized to prevent the service life of the power supply device from being harmed. According to different applications, those skilled in the art may observe appropriate alternations and modifications. Please refer to FIG. 4, which is a schematic diagram of another realization of the electronic system 10 shown in FIG. 1. The electronic system 10 shown in FIG. 4 is similar to the electronic system 10 shown in FIG. 2, thus signals and components with similar functions use the same symbols. In comparison with the electronic system 10 shown in FIG. 2, the comparing unit COM is realized by an amplifying unit Q3 which is similar to a smith trigger. The amplifying unit Q3 generates a high voltage threshold VTH_H and a low voltage threshold VTH_L according to the voltage threshold VTH. When the When the current value of the supply current SC is oversized and the current instruction signal CI exceeds the high voltage threshold VTH_H, the amplifying unit Q3 outputs the control signal CON instructing the supply current SC is oversized for making the performance adjusting module 110 controls the computing device 100 to enter the protection mode. On the other hand, when the current value of the supply current SC backs to normal region and the current instruction signal CI is smaller than the low voltage threshold VTH_L, the amplifying unit Q3 outputs the control signal CON instructing the supply current SC is normal for making the performance adjusting module 110 controls the computing device 100 to leave the protection mode. Accordingly, the electronic system 10 shown in FIG. 4 avoid misjudging whether the current value of the supply current SC exceeds the current threshold CTH due to the noise on the current instruction signal CI.

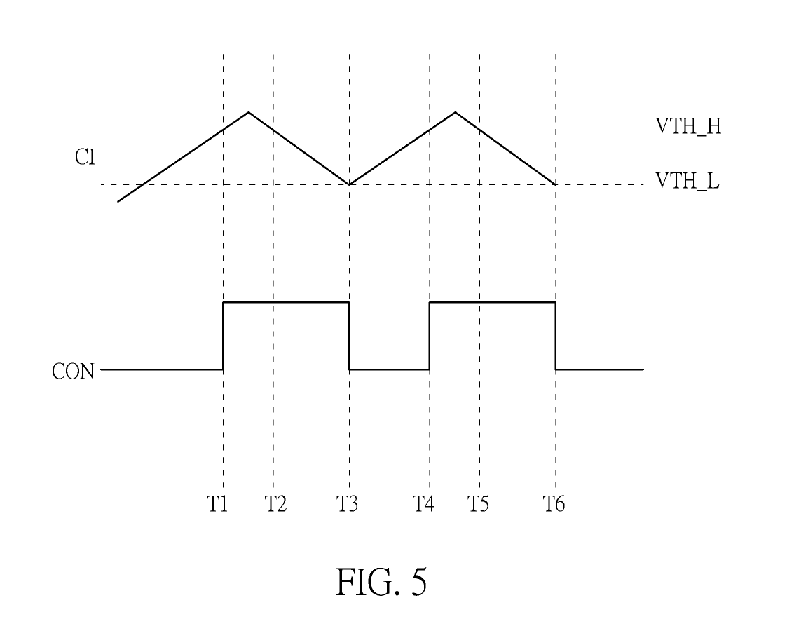

Please refer to FIG. 5, which is a schematic diagram of related signals when the electronic system 10 shown in FIG. 4 operates. As shown in FIG. 5, the current instruction signal CI gradually increases with the current value of the supply current SC gradually arises. At the time T1, the current instruction signal CI exceeds the high voltage threshold VTH_H, resulting in the control signal CON switches to a high logic. In such a condition, the performance adjusting module 110 controls the computing device 100 to enter the protection mode and the current value of the supply current SC is therefore decreased. Although the current instruction signal CI becomes smaller than the high voltage threshold VTH_H at the time T2, the control signal CON does not switch. The current instruction signal CI continuously decreases till a time T3. At the time T3, the current instruction signal CI decreases to be lower than the low voltage threshold VTH_L, resulting in the control signal CON switches to a low logic. The performance adjusting module 110 controls the computing device 100 to leave the protection mode, and so on. Accordingly, when the current instruction signal CI bounces between the high voltage threshold VTH_H and the low voltage threshold VTH_L, the control signal CON does not switch and the operation of the electronic system shown in FIG. 4 does not affected by the noise on the current instruction signal.

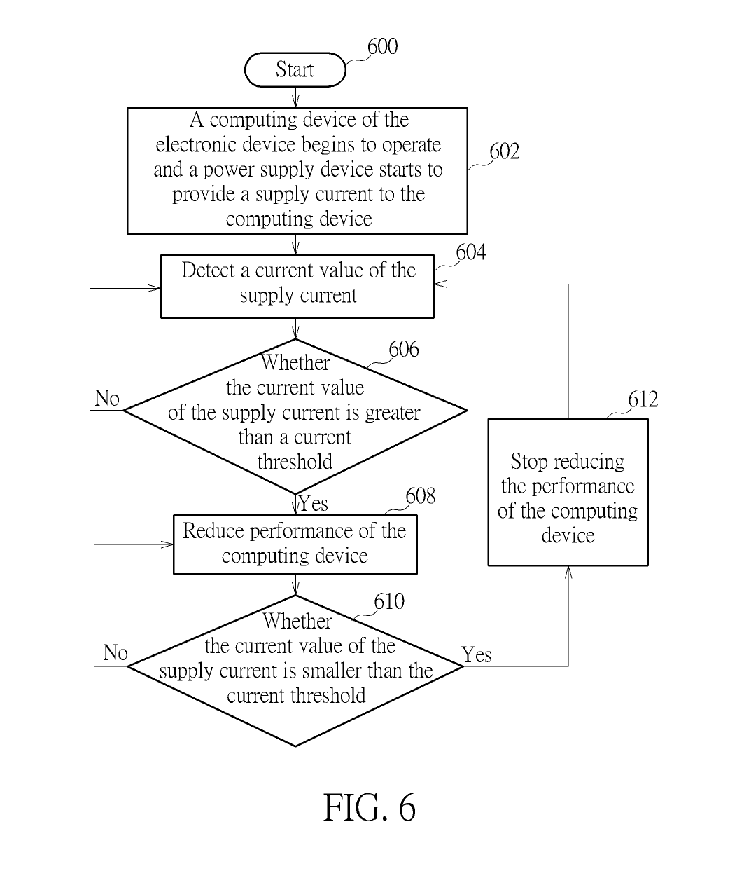

The method of the electronic system 10 adjusts the performance of the computing device 100 according to the current value of the supply current SC can be further summarized into a protection method 60 shown in FIG. 6. Noticeably, the protection method 60 is not limited to the sequence shown in FIG. 6 if a same result can be obtained.

The protection method 60 can be utilized in an electronic system and comprises the following steps:

Step 600: Start.

Step 602: A computing device of the electronic system begins to operate and a power supply device starts to provide a supply current to the computing device.

Step 604: Detect a current value of the supply current.

Step 606: Determine whether the current value of the supply current is greater than a current threshold. If the current value of the supply current is greater than the current threshold, perform step 608; otherwise, perform step 604.

Step 608: Reduce performance of the computing device.

Step 610: Determine whether the current value of the supply current is smaller than the current threshold. If the current value of the supply current is smaller than the current threshold, perform step 612; otherwise, perform step 608.

Step 612: Stop reducing the performance of the computing device.

According to the protection method 60, the performance of the computing device can be adjusted according to the supply current in the electronic system, to prevent the service life of the power supply device from being harmed by oversized supply current. According to different applications, those skilled in the art may observe appropriate alternations and modifications. For example, the current threshold of step 606 can be different from that of step 610, for avoiding misjudging the current value of the supply current due to noise.

To sum up, the protection device, the protection method and the electronic system of the above embodiments adjust the performance of the computing device according to the supply current for avoiding the service life of the power supply device being harmed by the oversized supply current.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A protection device for an electronic system, comprising:
a detecting module, coupled between a power supply device and a computing device of the electronic system for generating a current instruction signal according to a current value of a supply current transmitted from the power supply device to the computing device;
a determining module, coupled to the detecting module for generating a control signal according to the current instruction signal and at least one threshold; and
a performance adjusting module, coupled to the determining module and the computing device for adjusting performance of the computing device according to the control signal.

2. The protection device of claim 1, wherein the determining module adjusts the control signal when the current instruction signal instructs the current value of the supply current is greater than a first threshold, for controlling the performance adjusting module to reduce the performance of the computing device.

3. The protection device of claim 1, wherein the determining module adjusts the control signal when the current instruction signal instructs the current value of the supply current is smaller than a first threshold, for controlling the performance adjusting module to stop reducing the performance of the computing device.

4. The protection device of claim 1, wherein the detecting module comprises:
a sensing resistor, coupled between the power supply device and the computing device for generating a sensing voltage corresponding to the supply current according to the supply current transmitted from the power supply device to the computing device; and
an amplifying unit, coupled across the sensing resistor for generating a amplified sensing voltage according to the sensing voltage, as the current instruction signal.

5. The protection device of claim 4, wherein the determining module comprises:
a voltage generating unit, for generating a threshold voltage; and
a comparing unit, coupled to the amplifying unit and the voltage generating unit for generating the at least one threshold according to the threshold voltage and generating the control signal according to the at least one threshold and the amplified sensing voltage.

6. An electronic system, comprising:
a computing device;
a power supply device, for providing a supply current to the computing device; and
a protection device, comprising:
a detecting module, coupled between the power supply device and the computing device for generating a current instruction signal according to a current value of the supply current transmitted from the power supply device to the computing device;
a determining module, coupled to the detecting module for generating a control signal according to the current instruction signal and at least one threshold; and
a performance adjusting module, coupled to the determining module and the computing device for adjusting performance of the computing device according to the control signal.

7. The electronic system of claim 6, wherein the determining module adjusts the control signal when the current instruction signal instructs the current value of the supply current is greater than a first threshold, for controlling the performance adjusting module to reduce the performance of the computing device.

8. The electronic system of claim 6, wherein the determining module adjusts the control signal when the current instruction signal instructs the current value of the supply current is smaller than a first threshold, for controlling the performance adjusting module to stop reducing the performance of the computing device.

9. The electronic system of claim 6, wherein the detecting module comprises:
a sensing resistor, coupled between the power supply device and the computing device for generating a sensing voltage corresponding to the supply current according to the supply current transmitted from the power supply device to the computing device; and
an amplifying unit, coupled across the sensing resistor for generating a amplified sensing voltage according to the sensing voltage, as the current instruction signal.

10. The electronic system of claim 9, wherein the determining module comprises:
a voltage generating unit, for generating a threshold voltage; and
a comparing unit, coupled to the amplifying unit and the voltage generating unit for generating the at least one threshold according to the threshold voltage and generating the control signal according to the at least one threshold and the amplified sensing voltage.

11. A protection method for an electronic system, comprising:
detecting a current value of a supply current transmitted from a power supply device to a computing device of the electronic system; and
adjusting performance of the computing device according to the current value of the supply current and at least one threshold.

12. The protection method of claim 11, wherein the step of adjusting performance of the computing device according to the current value of the supply current and the at least one threshold comprises:
reducing the performance of the computing unit when the current value of the supply current is greater than a first threshold.

13. The protection method of claim 11, wherein the step of adjusting performance of the computing device according to the current value of the supply current and the at least one threshold comprises:
stopping reducing the performance of the computing unit when the current value of the supply current is smaller than a first threshold.
